(19) United States
(12) Patent Application Publication
(10) Pub. No.: US 2010/0000036 A1
(43) Pub. Date: Jan. 7, 2010

(54) Game Feeder Cleaning Device

(76) Inventors: Kevin Shipley, Arlington, TX (US); Michael W. Bentley, Arlington, TX (US)

Correspondence Address: WILSON DANIEL SWAYZE, JR., 3804 CLEARWATER CT., PLANO, TX, 75025, US

(21) Appl. No.: 12/168,634

(22) Filed: Jul. 7, 2008

(51) Int. Cl. B08B 9/04; A01K 5/00

(52) U.S. Cl. 15/104.09; 119/51.01

(57) ABSTRACT

A game feeder cleaning device to clean a game feeder may include a shaft member including a spiral channel and a spiral projection member to clean the game feeder, and a base member to connect to the shaft member and to cooperate with the game feeder in order to prevent game feed from leaving the gamefeeder. The shaft member may include a substantially smooth surface at a proximal end of the shaft member, and the base member may include a side member. The side member may include a curved edge, and the shaft member may include a traverse arm member. The traverse arm member may be positioned at a distal end of the shaft member.

### FIELD OF THE INVENTION

The present invention relates to game feeders, and more particular, relates to a game feeder cleaning device.

### BACKGROUND OF THE INVENTION

Selective game feeders are well known in the art and are designed to limit the maximum size of a game or animal which can access the seeds in the feeder. There are many reasons for excluding certain games and animals including the fact that certain games may be regarded as undesirable. Thus, many people only wish to have the smaller games present at the feeder and not the larger games. Some of the larger games such as crows, grackles, blue jays and the like are considered by some people to be undesirable.

A further problem associated with game feeders is those animals which gain access to the seeds and which can devour a large quantity of seeds in a relatively short period of time. Squirrels in particular are well known for their ability to reach the seeds in game feeders and have shown great ingenuity in overcoming many devices such as baffles which have been utilized in an attempt to solve the problem.

A further problem with game feeders is the tendency for food to be compressed towards the bottom of the game feeder. This results in the games having a difficult time reaching the food and removing the food from the game feeder. Furthermore, if the game food gets wet, then the game food will tend to stick together to form a mass in the bottom of the game feeder. This mass can resist being removed from the game feeder and may interfere with the operation of the game feeder. In some cases, this mass can grow until it represents a significant volume within the game feeder. At this time, the user of the game feeder must attempt to break up this mass without harming the game feeder. This can be a time-consuming and frustrating activity.

One of the more popular types of game feeders which are often referred to as squirrel proof are those which use a movable shroud. Thus, one may refer to U.S. Pat. No. 4,646,686 to Furlani which teaches a movable shroud.

A slightly different arrangement is shown in U.S. Pat. No. 3,145,690 to Bachman wherein there is an arrangement wherein an inverted cylinder hopper is suspended over a feeding pan while a game perch surrounds the pan and is attached to a conical shroud. Heavier games or animals on the perch cause the shroud to move downwardly.

Other arrangements are shown in U.S. Pat. Nos. 3,126,870; 6,543,384; 6,253,707 and 6,591,781. All of the teachings thereof are incorporated herein by reference.

U.S. Pat. No. 7,191,731 discloses a game feeder for deterring squirrels and other marauders, the game feeder having an inner feed container and an outer shroud, the spring mechanism being mounted in a center structure which comprises an outer first member having a hollow interior portion with a second plunger member mounted interiorly of the hollow member, the plunger having an upper stop member and a lower stop member with a spring mounted between the lower stop member and the base, the shroud being connected to an exteriorly extending portion of the plunger member.

Outer shroud is formed of a wire grid and is designed to substantially surround feed tube. As may be seen, there are provided portions wherein the wires are closely spaced together and which wires as well as portions having openings. As will be appreciated, where the wires are closely spaced, the purpose is to deny access to the feed tube, while, in a normal mode, openings provide access to the feed tube.

### SUMMARY

A game feeder cleaning device to clean a game feeder may include a shaft member including a spiral channel and a spiral projection member to clean the game feeder, and a base member to connect to the shaft member and to cooperate with the game feeder in order to prevent game feed from leaving the gamefeeder.

The shaft member may include a substantially smooth surface at a proximal end of the shaft member, and the base member may include a side member.

The side member may include a curved edge, and the shaft member may include a traverse arm member.

The traverse arm member may be positioned at a distal end of the shaft member.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of a game feeder cleaning device of the present invention;

FIG. 2 illustrates a top view of the game feeder cleaning device of the present invention;

FIG. 3 illustrates a perspective view of the game feeder cleaning device of the present invention;

FIG. 4 illustrates a side view of the game feeder and the game feeder cleaning device of the present invention.

### DETAILED DESCRIPTION

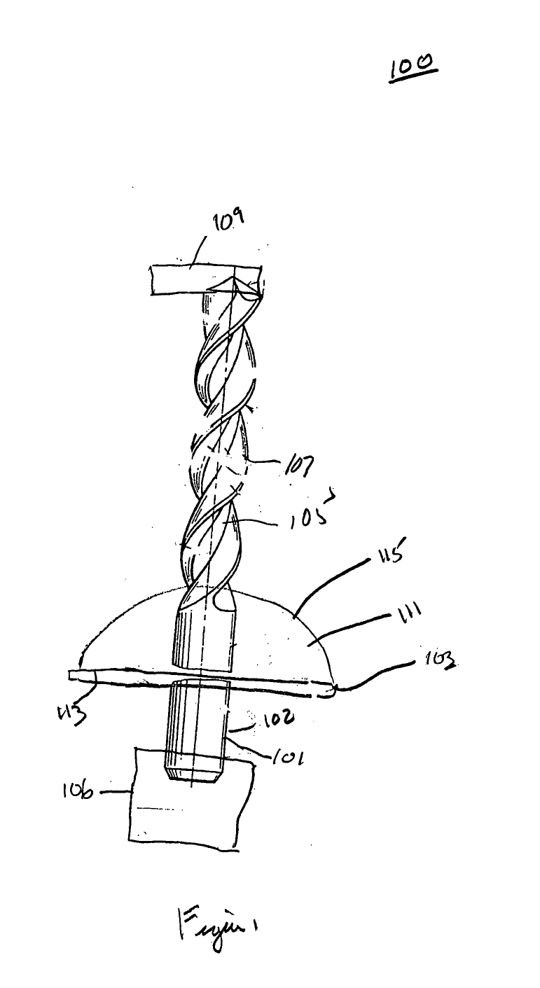

FIG. 1 illustrates the game feeder cleaning device 100 of the present invention. The game feeder cleaning device 100 includes a shaft member 101 which extends generally in the longitudinal direction of the game feeder cleaning device. The proximal end of the shaft member 101 includes a substantially smooth surface 102 in order for the proximal end of the shaft member 101 to be placed into a rotational device such as a drill in order to rotate the game feeder cleaning device 100 of the present invention. The shaft member 100 extends through and is connected to a base member 103 which may be rectangular or circular or other suitable shape in order to deflect any detached game feed as the game feeder cleaning device 100 enters the game feeder. The distal end of the shaft member 101 includes spiral channels 105 which spiral along the shaft member 101 in the longitudinal direction and forms a spiral projecting member 107 which extends outwards from the shaft member 101 in order to facilitate dislodging the game food from the game feeder. The shaft member 101 may be connected to a motor 106 which is activated according to a timer in order to stir the game feeder. The motor 106 allows for the continuous flow of feed from a barrel to the pan as the motor is operated. This operation helps keep the weight of the feed from being compacted in the feeder and stopping the flow of feed. If moisture reacts with the feed, the feed will tend to stick together interfering with the distribution of food. The present invention will break up to feed and allow the distribution of feed while the motor is in operation. The present invention works equally well with various sizes of feed, and the present invention prevents clogs of the feed under various weather conditions. The spiral projecting member 107 may be of varying thickness with the smallest thickness formed at the outermost edges of the spiral projecting member 107. Other embodiments may have a spiral projecting member 107 of constant thickness. FIG. 1 illustrates a traverse arm member 109 formed at the distal end of the shift member 101 in order to facilitate dislodging the game food from the game feeder. The base member includes a bottom member 113 and a side member 1 11 which has a curved top edge 115. The game feeder cleaning device 100 may be formed from a rigid material such as plastic, metal or other suitable material. As the game feeder cleaning device is rotated, the shaft member 101 rotates and the edges of the spiral projecting member 107 and the traverse arm member 109 engage the game food which has become lodged within the game feeder.

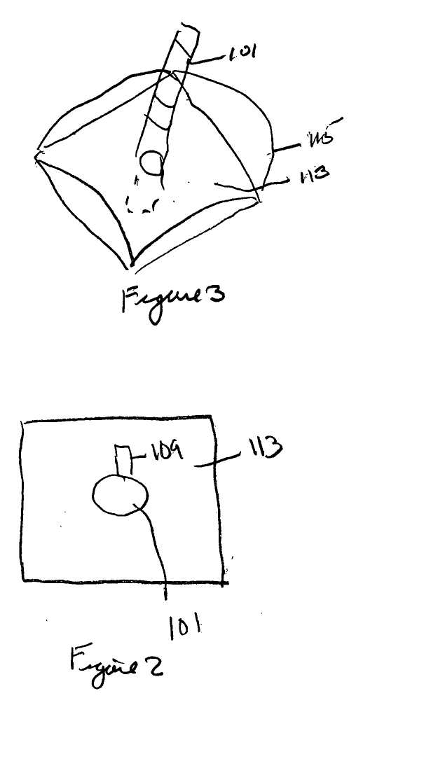

FIG. 2 illustrates a top view of the game feeding device 100 and shows the bottom member 113 of the base member 103, the shaft member 101 and the traverse arm member 109 which extends from the shaft member 101.

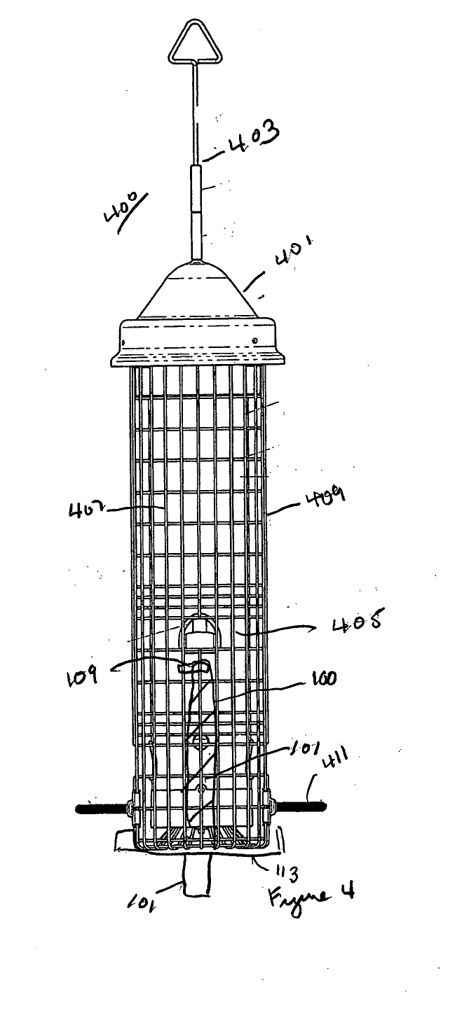

FIG. 3 illustrates a perspective view of the game feeder cleaning device 100 of the present invention. FIG. 3 illustrates the shaft member 101 which extends through the bottom member 113 of the base member 103.

FIG. 4 illustrates the game feeder cleaning device 100 cooperating with a game feeder 400. The game feeder 400 includes a shroud member 405 which is covered by a dome cover member 401 which is connected to a hangar member 403 to hang the game feeder 400. The shroud member 405 includes a wire grid 407 to prevent large games and animals from reaching the food within the game feeder 400. The shroud member 405 includes a tube member 409 which includes opening to provide access to the food within the game feeder 400. The game feeder 400 additionally includes a perch member 411 to provide a place for the game to perch while accessing the openings within the tube member 409.

FIG. 4 additionally illustrates the game feeding cleaning device 100 positioned through the bottom of the game feeder 400 the bottom member 113 of the game feeding device 100 is positioned to abut the bottom of the game feeder 400 to prevent game feed from falling out the bottom of the game feeder 400, and the shaft member 101 extends within the tube member 409 of the game feeder 400.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A game feeder cleaning device to clean a game feeder, comprising:
a shaft member including a spiral channel and a spiral projection member to clean the game feeder;
a base member to connect to the shaft member and to cooperate with the game feeder in order to prevent game feed from leaving the game feeder.

2. A game feeder cleaning device to clean a game feeder as in claim 1, wherein the shaft member includes a substantially smooth surface at a proximal end of the shaft member.

3. A game feeder cleaning device to clean a game feeder as in claim 1, wherein the base member includes a side member.

4. A game feeder cleaning device to clean a game feeder as in claim 3, wherein the side member includes a curved edge.

5. A game feeder cleaning device to clean a game feeder as in claim 1, wherein the shaft member includes a traverse arm member.

6. A game feeder cleaning device to clean a game feeder as in claim 5, wherein the traverse arm member is positioned at a distal end of the shaft member.
